(19) United States
(12) Patent Application Publication
(10) Pub. No.: US 2007/0265393 A1
(43) Pub. Date: Nov. 15, 2007

(54) Composition for low-odor thermoplastic resin

(76) Inventors: Dong Cheol Sohn, Ulsan (KR); Je Ryoung Lee, Ulsan (KR); Bong Hyun Park, Gunpo-si (KR); Jae Hong Kim, Incheon (KR); Soon Joon Jung, Hwaseong-si (KR); Yong Chul Lee, Gyeongju-si (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/648,862

(22) Filed: Dec. 29, 2006

(30) Foreign Application Priority Data
May 10, 2006 (KR) 10-2006-0042060
Jul. 3, 2006 (KR) 10-2006-0062058

(51) Int. Cl. C08G 63/48

(52) U.S. Cl. 525/71

(57) ABSTRACT

The present invention relates to a low-odor thermoplastic resin composition. In particular the resin of the resin composition is prepared by a new bulk polymerization process that is used to reduce the characteristic chemical odor in new cars. The resin minimizes the use of the resin prepared by the conventional emulsion polymerization process, N-substituted maleimide and α-alkylstyrene-based heat-resistant materials which are used to improve heat resistance and the molecular weight of the matrix of the thermoplastic composition. The resin is also improves impact strength, thereby having reduced characteristic chemical odor, while having superior impact strength and heat resistance.

### CROSS-REFERENCE TO RELATED APPLICATION

The application claims priority to Korean Patent Application No. 10-2006-0042060 filed in the Korean Intellectual Property Office on May 10, 2006, and Korean Patent Application No. 10-2006-0062058 filed in the Korean Intellectual Property Office on Jul. 3, 2006, the disclosures of which are incorporated herein by reference.

### BACKGROUND OF THE INVENTION

(a) Field of the Invention

The present invention relates to a low-odor thermoplastic resin composition.

(b) Description of the Related Art

Conventionally used acrylonitrile-butadiene-styrene (“ABS”) copolymer resin consists of a) a graft rubber component in the dispersed phase, which is also called the domain, and b) an acrylonitrile-styrene (“SAN”) copolymer resin in the continuous phase, which is also called the matrix. In products requiring good heat resistance (i.e. electric/electronic appliances, outdoor advertisements and automobile parts), some of the monomers are replaced by α-alkylstyrene, which has a high glass transition temperature (T_{g}) and thus has superior heat resistance in the domain phase to improve heat resistance. Alternatively, some of the matrix phase is replaced by α-alkylstyrene or N-substituted maleimide-based resin.

The conventional method is advantageous in attaining good impact property and heat resistance. However, since the graft rubber component and the α-alkylstyrene-based resin, etc. are prepared by emulsion polymerization, 80% or more low molecular weight additives remain in the final product. Especially for automobile interior parts, these remaining additives discharge volatile organic compounds, which offend passengers with characteristic chemical odor. With the requirement from the auto industry and the ever-changing trend, improvement of the chemical odor while maintaining superior physical properties has become an important issue for the materials makers.

### SUMMARY OF THE INVENTION

The present invention provides a low-odor thermoplastic resin composition comprising: a) about 25 wt % to about 45 wt % of a bulk polymerized, unsaturated nitrile-diene rubber-aromatic vinyl monomer resin having a large particle diameter; b) about 5 wt % to about 15 wt % of an emulsion polymerized, unsaturated nitrile-diene rubber-aromatic vinyl monomer resin; c) about 20 wt % to about 30 wt % of a bulk polymerized, unsaturated nitrile-aromatic vinyl monomer resin; d) about 10% wt % to about 20 wt % of a bulk polymerized α-alkylstyrene-unsaturated nitrile-styrene resin; and e) about 10% wt % to about 20 wt % of a solution polymerized N-substituted maleimide-unsaturated vinyl monomer resin.

In an exemplary embodiment of the invention, the low-odor thermoplastic resin composition comprises a) the unsaturated nitrile is selected from the group consisting of acrylonitrile, methacrylonitrile and ethacrylonitrile; b) the diene rubber is selected from the group consisting of a butadiene rubber and an isoprene rubber; c) the aromatic vinyl monomer is selected from the group consisting of styrene, α-methylstyrenevinyltoluene, t-butylstyrene, halogen-substituted styrene and a mixture thereof; d) the α-alkylstyrene is selected from the group consisting of α-methylstyrene, α-ethylstyrene and methyl-α-methylstyrene; and e) the N-substituted maleimide is selected from the group consisting of N-phenylmaleimide, N-(2-methylphenyl)maleimide, N-laurylmaleimide, N-benzylmaleimide, N-chlorophenylmaleimide and N-dichlorophenylmaleimide.

In another exemplary embodiment of the invention, the low-odor thermoplastic resin composition comprises the bulk polymerized, unsaturated nitrile-diene rubber-aromatic vinyl monomer resin which has a particle size of about 1 μm to about 4 μm.

### BRIEF DESCRIPTION OF THE DRAWINGS

FIG. 1 illustrates the structure of an ABS resin.

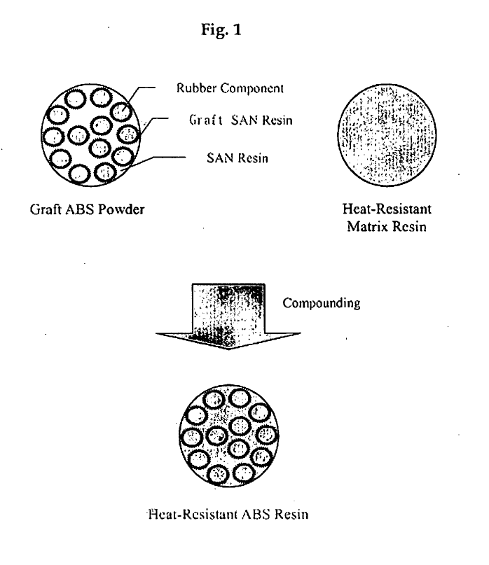

FIG. 2 illustrates an exemplary embodiment of the present invention.

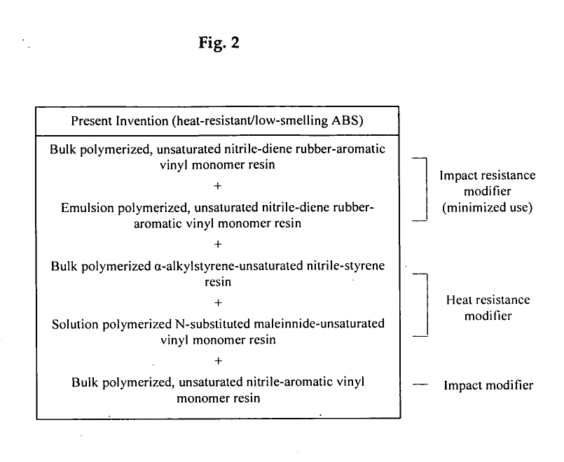

### DETAILED DESCRIPTION OF THE EMBODIMENTS

In order to solve the fundamental problems of conventional emulsion polymerized products including a variety of low molecular weight additives, which generate volatile organic compounds, the main cause of chemical odor, the present invention provides a bulk polymerized, unsaturated nitrile-diene rubber-aromatic vinyl monomer resin having a large particle diameter. The present invention provides for bulk polymerization process which eliminates the cause of chemical odor. The present invention reduces the use of an emulsion polymerized, unsaturated nitrile-diene rubber-aromatic vinyl monomer, which is added to improve impact property. The present invention optimizes the proportion of a bulk polymerized α-alkylstyrene-unsaturated nitrile-styrene resin to a solution polymerized N-substituted maleimide-unsaturated vinyl monomer resin which satisfy the heat resistance requirement needed for car interior materials. The present invention uses high molecular weight to compensate for the impact property, which can be reduced because of the addition of the N-substituted maleimide.

In one embodiment, a low-odor thermoplastic resin composition is provided which reduces chemical odor while maintaining superior heat resistance and impact property.

The present invention is characterized by a low-odor thermoplastic resin composition comprising: about 25 wt % to about 45 wt % of a bulk polymerized, unsaturated nitrile-diene rubber-aromatic vinyl monomer resin having a large particle diameter, about 5 wt % to about 15 wt % of an emulsion polymerized, unsaturated nitrile-diene rubber-aromatic vinyl monomer resin, about 20% to about 30 wt % of a bulk polymerized, unsaturated nitrile-aromatic vinyl monomer resin, about 10 wt % to about 20 wt % of a bulk polymerized α-alkylstyrene-unsaturated nitrile-styrene resin and about 10 wt % to about 20 wt % of a solution polymerized N-substituted maleimide-unsaturated vinyl monomer resin.

The present invention relates to a low-odor thermoplastic resin composition having significantly reduced chemical odor while having superior heat resistance. In particular the thermoplastic composition has an impact (notched impact) strength of about 15 to about 20, a tensile strength of about 470 to about 510, a heat deflection temperature (HDT) of about 100° C. to about 107° C. and an odor rating of about 4.0 which is prepared by blending about 25 wt % to about 45 wt % of a bulk polymerized, unsaturated nitrile-diene rubber-aromatic vinyl monomer resin having a large particle diameter, about 5 wt % to about 15 wt % of an emulsion polymerized, unsaturated nitrile-diene rubber-aromatic vinyl monomer resin, about 20 wt % to about 30 wt % of a bulk polymerized, unsaturated nitrile-aromatic vinyl monomer resin, about 10 wt % to about 20 wt % of a bulk polymerized α-alkylstyrene-unsaturated nitrile-aromatic vinyl monomer resin and about 10 wt % to about 20 wt % of a solution polymerized N-substituted maleimide-unsaturated vinyl monomer resin.

If the content of the bulk polymerized, unsaturated nitrile-diene rubber-aromatic vinyl monomer resin has a large particle diameter (about 1 μm to about 4 μm) is less than about 25 wt %, impact strength may decrease. In contrast, if it exceeds about 45 wt %, tensile strength may become significantly deteriorated. If the emulsion polymerized, unsaturated nitrile-diene rubber-aromatic vinyl monomer resin is used in less than about 5 wt %, impact resistance may decrease. In contrast, if it is used in excess of about 15 wt %, the chemical odor may not be reduced. If the bulk polymerized, unsaturated nitrile-aromatic vinyl monomer resin is used in less than about 20 wt %, impact strength resistance may decrease. In contrast, if it is used in excess of about 30 wt %, heat resistance may be weakened. If the bulk polymerized α-alkylstyrene-unsaturated nitrile-aromatic vinyl monomer resin is used in less than about 10 wt %, an adequate heat resistance may not be attained. In contrast, if it is used in excess of about 20 wt %, impact resistance may be weakened and it is difficult to attain good heat resistance. If the solution polymerized N-substituted maleimide-unsaturated vinyl monomer resin is used in less than about 10 wt %, it is difficult to attain good heat resistance. In contrast, if it is used in excess of about 20 wt %, impact resistance may be weakened.

Exemplary diene rubber includes, but is not limited to, a butadiene rubber and an isoprene rubber. Exemplary unsaturated nitrile includes, but is not limited to, acrylonitrile, methacrylonitrile, and α-chloroacrylonitrile. Exemplary aromatic vinyl monomer includes, but is not limited to, styrene, α-methylstyrenevinyltoluene, t-butylstyrene, halogen-substituted styrene and a mixture thereof. Exemplary α-alkylstyrene includes, but is not limited to, α-methylstyrene, α-ethylstyrene and methyl-α-methylstyrene. Exemplary N-substituted maleimide includes, but is not limited to, N-phenylmaleimide, N-(2-methylphenyl)maleimide, N-laurylmaleimide, N-benzylmaleimide, N-chlorophenylmaleimide and N-dichlorophenylmaleimide.

The present invention provides a bulk polymerization process which reduces chemical odor. The emulsion polymerized resin is minimized in consideration of the final physical properties. For improvement of heat resistance, N-substituted maleimide is used along with α-alkylstyrene. Further, the molecular weight of the matrix of the thermoplastic composition is increased to compensate for the reduced impact strength. Consequently, the chemical odor can be minimized while offering superior impact strength and heat resistance.

### EXAMPLES 1-5

A resin mixture comprises a) an acrylonitrile-butadiene-styrene bulk copolymer and an acrylonitrile-butadiene-styrene emulsion copolymer having a large particle diameter which acts as an impact strength modifier, b) an α-methylstyrene-acrylonitrile-styrene bulk copolymer and an N-phenylmaleimide-styrene solution copolymer which serves as a heat-resistant material, c) an acrylonitrile-styrene bulk copolymer having an average molecular weight (M_{w}) of about 150,000 daltons to about 250,000 daltons and serves as an impact modifier, d) N,N′-ethylenebisstearamide which acts as a lubricant, and e) a phenyl antioxidant which is mixed homogeneously for about 10 minutes with a tumbler. Subsequently, the mixture was extruded with an extruder (25Φ Twin Extruder, W&P) at a cylinder temperature of about 195° C. to about 260° C. to obtain a pellet. The pellet was dried in a conventional oven at about 90° C. for about 3 hours in order to measure heat resistance and other physical properties. The measurement results are given in Table 1 below.

a) Measurement of physical properties: Test sample was prepared from the pellet using a 4.0-ounce extruder (DongShin Hydraulics) or an equivalent according to the ASTM standard for measuring IZOD impact strength, tensile strength and heat deflection temperature.

b) Measurement of total Volatile Organic Compounds (“VOCs”): About 1000 mg of the pellet sample was put in a tube. Through gas collection, pyrolysis and desorption, the content of volatile organic compounds, which is the fundamental cause of the chemical odor, was quantitatively analyzed using an H.S.S-GC/MASS spectrometer.

c) Odor test: Test was performed as follows according to the MS 300-34 standard of Hyundai Motor Company, which is similar to those of leading automobile companies abroad (Ford, GM, Toyota, etc).

a. Standard test conditions
23±2° C., R.H. 65±5%, unless specified otherwise.
Test sample should be kept at this condition at least for 25 hours.

b. Sampling
Test sample size: 100 mm wide, 100 mm long.

c. Test sample is put in a 3L container. The container is sealed and put in a constant-temperature bath of 80±2° C. for 3 hours. 3 or 4 testers smell and rate the sample.

d. Odor rating

| Rating | |
|---|---|
| 5 | No smell. |
| 4 | Smells slightly. |
| 3 | Smells a little, but acceptable. |
| 2 | Smells strongly, but not intolerable. |
| 1 | Offensive and intolerable smell. |

TABLE 1

| Acrylonitrile-butadiene-styrene bulk copolymer (wt %) | | 25 | 30 | 35 | 40 | 45 |
|---|---|---|---|---|---|---|
| [ET-70, Nippon A & L] | | | | | | |
| Acrylonitrile-butadiene-styrene emulsion copolymer (wt %) | | 15 | 13 | 11 | 7 | 5 |
| [Grafted ABS, Kumho Petrochemical] | | | | | | |
| α-Methylstyrene-acrylonitrile-styrene bulk copolymer (wt %) | | 10 | 12 | 14 | 17 | 20 |
| [Bulk heat-resistant SAN, Kumho Petrochemical] | | | | | | |
| N-Phenylmaleimide-styrene solution copolymer (wt %) | | 20 | 17 | 14 | 12 | 10 |
| [MS-NB, Denka] | | | | | | |
| High molecular weight acrylonitrile-styrene bulk copolymer | | 30 | 28 | 26 | 24 | 20 |
| (wt %) | | | | | | |
| [Bulk general-purpose SAN, Kumho Petrochemical] | | | | | | |
| Ethylenebisstearamide (per 100 parts by weight of the | | 1.0 | 1.0 | 1.0 | 1.0 | 1.0 |
| copolymer) | | | | | | |
| Phenyl antioxidant (per 100 parts by weight of the | | 0.5 | 0.5 | 0.5 | 0.5 | 0.5 |
| copolymer) | | | | | | |
| Mechanical | IZOD impact strength (kg · cm/cm) | 20 | 17 | 20 | 19 | 17 |
| properties | Tensile strength (kg/cm²) | 500 | 485 | 490 | 480 | 470 |
| | Heat deflection temperature (° C.) | 107 | 104 | 105 | 103 | 101 |
| Analysis result | Total VOCs (×10⁶) | 79 | 65 | 60 | 63 | 70 |
| | Odor rating | 4 | 4 | 4 | 4 | 4 |

### Comparative Examples 1-5

A resin mixture comprises a) an acrylonitrile-butadiene-styrene emulsion copolymer which serves as an impact resistance modifier, b) an α-methylstyrene-acrylonitrile emulsion copolymer c) a N-phenylmaleimide-styrene solution copolymer which serves as a heat-resistant material, d) a low molecular weight acrylonitrile-styrene bulk copolymer having an average molecular weight (M_{w}) of about 80,000 daltons to about 110,000 daltons, e) N,N′-ethylenebisstearamide which serves as a lubricant, and f) a phenyl antioxidant which is mixed homogeneously for 10 minutes with a tumbler. Subsequently, the mixture was extruded with an extruder (25Φ Twin Extruder, W&P) at a cylinder temperature of about 195° C. to about 260° C. to obtain a pellet. The pellet was dried in a convention oven at about 90° C. for about 3 hours in order to measure heat resistance and other physical properties. The measurement results are given in Table 2 below.

Physical properties, total VOCs and odor were tested as in Examples above.

TABLE 2

| | | Comparative Example | | | | |
|---|---|---|---|---|---|---|
| | | 1 | 2 | 3 | 4 | 5 |
| Acrylonitrile-butadiene-styrene emulsion copolymer (wt %) | | 30 | 35 | 30 | 35 | 30 |
| α-Methylstyrene-acrylonitrile emulsion copolymer (wt %) | | 70 | — | 40 | 30 | 20 |
| N-Phenylmaleimide-styrene solution copolymer (wt %) | | — | 30 | 20 | 30 | — |
| Low molecular weight acrylonitrile-styrene bulk copolymer | | — | 35 | 10 | 5 | 20 |
| (wt %) | | | | | | |
| Ethylenebisstearamide (per 100 parts by weight of the | | 0.8 | 0.8 | 0.8 | 0.8 | 0.8 |
| copolymer) | | | | | | |
| Phenyl antioxidant (per 100 parts by weight of the | | 0.6 | 0.6 | 0.6 | 0.6 | 0.6 |
| copolymer) | | | | | | |
| Mechanical | IZOD impact strength (kg · cm/cm) | 13 | 15 | 15 | 13 | 17 |
| properties | Tensile strength (kg/cm²) | 490 | 480 | 470 | 485 | 460 |
| | Heat deflection temperature (° C.) | 98 | 99 | 101 | 98.5 | 97 |
| Analysis result | Total VOCs (×10⁶) | 850 | 750 | 800 | 810 | 830 |
| | Odor rating | 2 | 3 | 2 | 2 | 2 |

By replacing the conventional emulsion polymerization process with a new bulk polymerization process, the present invention significantly reduces the characteristic chemical odor in new cars.

Also, the N-substituted maleimide and α-alkylstyrene heat-resistant materials enhance heat resistance and increase molecular weight of the matrix of the thermoplastic composition by compensating for the reduction of impact strength, thereby minimizing the chemical odor while maintaining superior impact strength and heat resistance.

Those skilled in the art will appreciate that the concepts and specific embodiments disclosed in the foregoing description may be readily utilized as a basis for modifying or designing other embodiments for carrying out the purposes of the present invention. Those skilled in the art will also appreciate that such equivalent embodiments do not depart from the spirit and scope of the present invention as set forth in the appended claims.

What is claimed is:

1. A low-odor thermoplastic resin composition comprising:
a) about 25 wt % to about 45 wt % of a bulk polymerized, unsaturated nitrile-diene rubber-aromatic vinyl monomer resin having a large particle diameter;
b) about 5 wt % to about 15 wt % of an emulsion polymerized, unsaturated nitrile-diene rubber-aromatic vinyl monomer resin;
c) about 20 wt % to about 30 wt % of a bulk polymerized, unsaturated nitrile-aromatic vinyl monomer resin;
d) about 10% wt % to about 20 wt % of a bulk polymerized α-alkylstyrene-unsaturated nitrile-styrene resin; and
e) about 10% wt % to about 20 wt % of a solution polymerized N-substituted maleimide-unsaturated vinyl monomer resin.

2. The low-odor thermoplastic resin composition as set forth in claim 1, wherein
a) the unsaturated nitrile is selected from the group consisting of acrylonitrile, methacrylonitrile and ethacrylonitrile;
b) the diene rubber is selected from the group consisting of a butadiene rubber and an isoprene rubber;
c) the aromatic vinyl monomer is selected from the group consisting of styrene, α-methylstyrenevinyltoluene, t-butylstyrene, halogen-substituted styrene and a mixture thereof;
d) the α-alkylstyrene is selected from the group consisting of α-methylstyrene, α-ethylstyrene and methyl-α-methylstyrene; and
e) the N-substituted maleimide is selected from the group consisting of N-phenylmaleimide, N-(2-methylphenyl)maleimide, N-laurylmaleimide, N-benzylmaleimide, N-chlorophenylmaleimide and N-dichlorophenylmaleimide.

3. The low-odor thermoplastic resin composition as set forth in claim 1, wherein the bulk polymerized, unsaturated nitrile-diene rubber-aromatic vinyl monomer resin has a particle size of about 1 μm to about 4 μm.
